(19) United States
(12) Patent Application Publication
(10) Pub. No.: US 2010/0244539 A1
(43) Pub. Date: Sep. 30, 2010

(54) VEHICLE SEATING MATERIAL WITH HYDROGRAPHIC DESIGN

(76) Inventor: Chris Kardassilaris, Dublin, OH (US)

Correspondence Address: Emerson, Thomson & Bennett, LLC, 1914 Akron-Peninsula Road, Akron, OH, 44313, US

(21) Appl. No.: 12/413,879

(22) Filed: Mar. 30, 2009

(51) Int. Cl. B60N 2/58

(52) U.S. Cl. 297/452.58; 427/323

(57) ABSTRACT

A vehicle seat assembly that supports a person in a sitting position may have a seat cushion that cushions the person while sitting. A piece of seating material that is formed of leather and/or faux leather may have an inner side that covers at least a portion of an outer surface of the cushion and an outer side that has a hydrographically applied printing design thereon.

### I. BACKGROUND OF THE INVENTION

A. Field of Invention

This invention pertains to the art of methods and apparatuses regarding vehicle seats, and more particularly to methods and apparatuses regarding the application of hydrographic designs to vehicle seating materials.

B. Description of the Related Art

Thermoforming film is one of the automotive standard technologies for decorative trim. The use of thermoforming film, however, has limitations. One limitation concerns the shape of the part being trimmed. Specifically, there is a limitation to the radius of the part that can be used during the thermoforming film process due to the poor appearance of the wrapped film that is stretched onto the part.

Hydrographics is an advanced printing technology that allows for the mass production of decorative trim parts with a wide variety of patterns without the limitations of thermoforming film. Hydrographic technology, unlike thermoforming film, is applicable to parts that are to have decorative printing applied to their surfaces even with reduced radii. Hydrographic technology is capable of achieving a 360 degree wrap with an excellent fit and finish. Hydrographic technology is based on a water-soluble film. The water-soluble film, typically composed of poly-vinyl alcohol (PVA), has the desired ink pattern applied to its surface. A protective film is then applied onto the PVA to protect the hydrographic film prior to production.

The general process for applying hydrographic printing to a part is as follows. The protective film is removed and the PVA is placed into a moving water bath. In the water, the PVA swells and dissolves leaving the ink pattern floating across the water bath. The next step is called activation, typically accomplished by a spray activator. Before the activator is applied to the film, the ink is stable and will not transfer onto parts. In this step the activator interacts with the ink to make it chemically active and thus able to adhere to the part. The part is then dipped into the water to transfer the ink pattern. The part next goes through a washing procedure and a drying procedure. Finally, the part goes through a topcoat application system, typically done by a spray applicator, and is heat cured to firmly attach the topcoat to the part. It should be noted that other methods of applying the activator and topcoat are also known.

Hydrographic technology is known to be applied to automotive parts but only relatively hard parts such as those composed of traditional hard plastics (polypropylene, polycarbonate, polyethylene, acrylonitrile butadiene styrene, etc.), metals, and wood composites. Some of the limitations preventing the application of hydrographic technology to other parts include: parts that go through excessive wear; parts that stretch or elongate during assembly or use; and, parts that require significant process changes to accommodate hydrographic technology.

What is needed is a method of using hydrographic technology with relatively soft and/or elastic parts, such as vehicle seating materials.

### II. SUMMARY OF THE INVENTION

According to one embodiment of the invention, a vehicle seat assembly comprises: a seat assembly that supports an associated person in a sitting position and that is operatively attachable to an associated vehicle, the seat assembly comprising a first seat cushion that cushions the associated person while sitting; and, a first piece of seating material that is operatively attached to the seat assembly and that is formed of one of leather and faux leather, the first piece of seating material having an inner side that covers at least a portion of an outer surface of the first cushion and an outer side opposite the inner side that has a hydrographically applied printing design thereon.

According to another embodiment of the invention, a method includes the steps of: (A) providing a leather hide; (B) applying a first base coat to the leather hide; (C) applying a hydrographic pattern to the leather hide; and, (D) applying a topcoat to the leather hide.

According to yet another embodiment of the invention, a method includes the steps of: (A) providing a faux leather piece; (B) preforming the faux leather piece so that it become suited for hydrographics; (C) applying a hydrographic pattern to the faux leather piece; and, (D) applying a topcoat to the faux leather piece.

One advantage of this invention is that hydrographic printing can be applied to leather seating materials.

Another advantage of this invention is that hydrographic printing can be applied to faux leather seating materials.

Still other benefits and advantages will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a perspective view of a vehicle.

FIG. 2 is a perspective view of a seat assembly having seating material according to one embodiment of this invention.

FIG. 3 is a table showing a prior art process flow for the finishing of leather.

FIG. 4 is a table showing a prior art calandering process flow for faux leather.

FIG. 5 is a table showing a process flow for the application of hydrogaphics to leather according to one embodiment of this invention.

FIG. 6 is a table showing a calandering process flow for the application of hydrogaphics to faux leather according to one embodiment of this invention.

### IV. DETAILED DESCRIPTION OF THE INVENTION

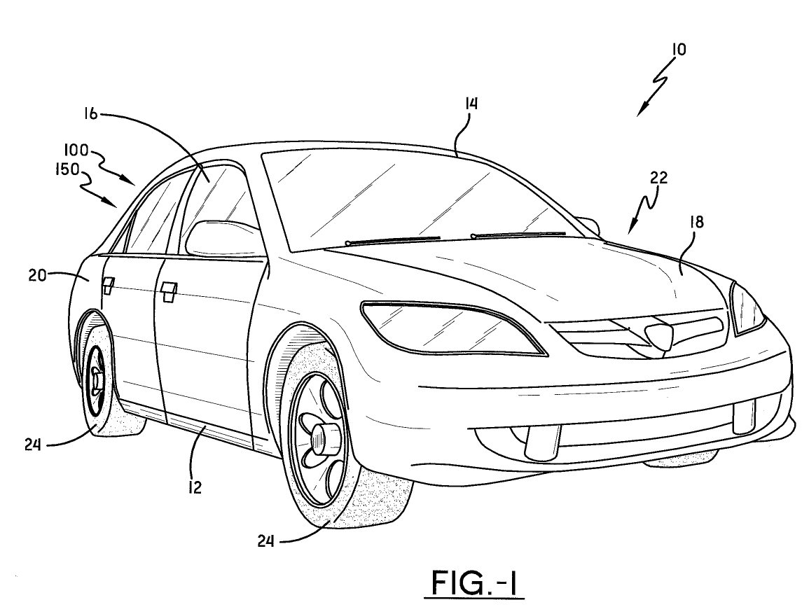

Referring now to the drawings wherein the showings are for purposes of illustrating embodiments of the invention only and not for purposes of limiting the same, and wherein like reference numerals are understood to refer to like components, FIG. 1 shows a vehicle 10 equipped with a vehicle seat assembly 100 using vehicle seating material 150 according to one embodiment of this invention. It should be noted that while an automotive passenger vehicle is shown, the inventive vehicle seating material 150 will work well with other vehicles including all types of trucks, motorcycles, all-terrain vehicles (ATVs), sport utility vehicles (SUVs), vans, boats, airplanes, etc., and for other purposes as well. The vehicle 10 may include a vehicle frame 12 and a body 14 that is supported to the frame 12. The body 14 may define a passenger compartment 16, which may include one or more of the vehicle seat assemblies 100 as will be discussed further below. The body 14 may also define a locomotion compartment 18 and a storage compartment (or trunk) 20. The locomotion compartment 18 may contain at least one locomotion device 22 to provide power to move the vehicle from place to place. The particular locomotion device 22 can be any chosen with the sound judgment of a person of skill in the art. Non-limiting examples include: internal combustion engines (ICEs), electric motors, and hybrids (which typically include both an ICE and an electric motor). The vehicle 10 may include one or more ground engaging wheels 24 and other conventional components of a vehicle that are known in the art.

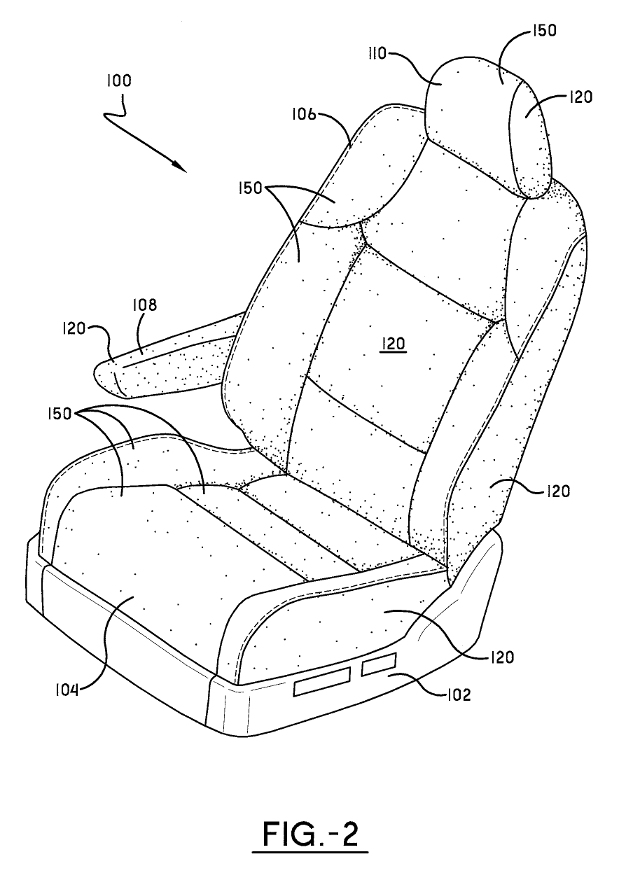

With reference now to FIGS. 1-2, the seat assembly 100, one or more of which may be placed within the passenger compartment 16, is shown partially cut-away in FIG. 2 so that details may be better seen. It should be noted that while the seat assembly 100 shown is commonly referred to as a bucket seat (designed to support one person in a sitting position), the inventive vehicle seating material 150 will work well with other seat assemblies including bench seats (designed to support more than one person in a sitting position) of all sizes and seat surfaces of many types. The seat assembly 100 may include a support structure 102 that is attachable to the vehicle 10 in any manner chosen with the sound judgment of a person of skill in the art. The seat assembly 100 may also include a seat base portion 104, a seat back portion 106, one or more arm rests 108, and one or more neck braces 110 though it is to be understood that these components are not required for this invention. One or more seat cushions 120 may be used to cushion the person sitting in the seat assembly 100 as is commonly known. Each seat cushion 120 may be covered by seating material 150 made according to this invention and discussed further below.

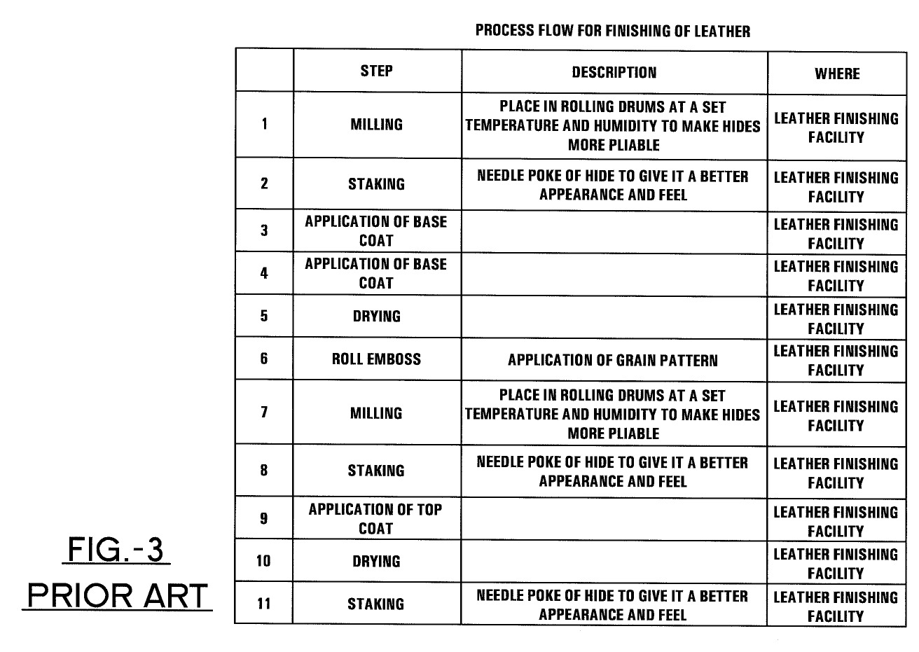

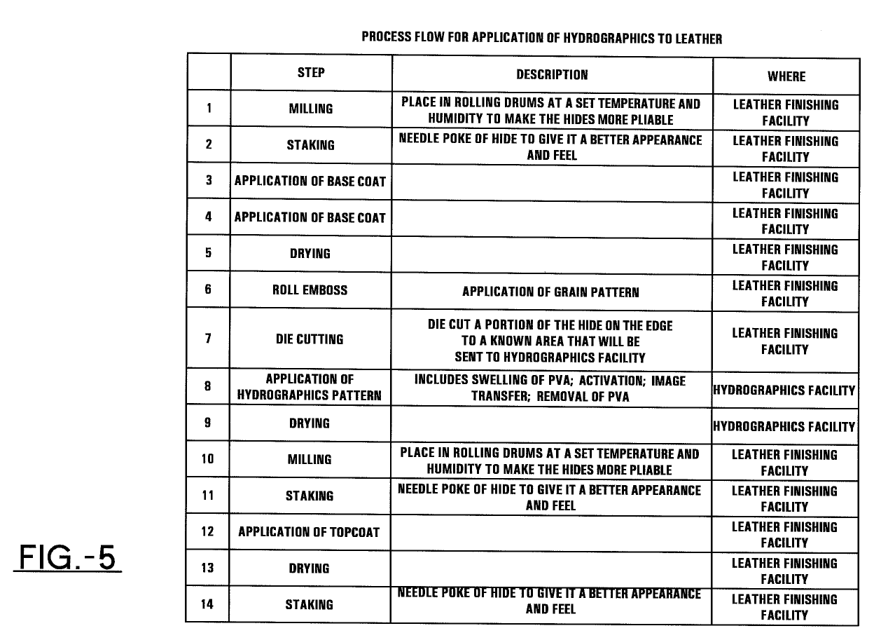

With reference now to FIGS. 2-3 and 5, the underlying seating materials 150 subject to this invention are those formed primarily of leather and/or faux leather. Hydrographic printing designs are applied onto the seating materials 150 which are then applied to one or more of the seat cushions 120. To better understand the leather embodiments of the invention, FIG. 3 shows a typical process flow for the finishing of leather without hydrographic printing, such as may be used to make leather seating material. To apply a hydrographic printing design to leather seating material, additional steps are required. FIG. 5 shows one embodiment of a process flow for the finishing of leather with hydrographic printing, such as may be used to make leather seating material. It should be noted that the process flows shown in FIGS. 3 and 5 are exemplary only (not every step is required in all applications) and should not be used to limit this invention in any manner. The additional steps shown in FIG. 5 are steps 7, 8 and 9. For step 7, the leather hide is die cut in a predetermined location to create a specific area upon which the hydrographic printing design will be applied. This step is not required for all applications. For step 8, the application of the hydrographic printing design in one embodiment may include the same steps as discussed above regarding the general process for applying hydrographic printing to a part. Note that for the embodiment shown, the location where steps 1-7 and 10-14 occur is a leather finishing facility and the location where steps 8-9 occur is at a hydrographics facility that is not at the same site as the leather finishing facility. In an alternate embodiment, the hydrographics facility may be at the same site as the leather finishing facility.

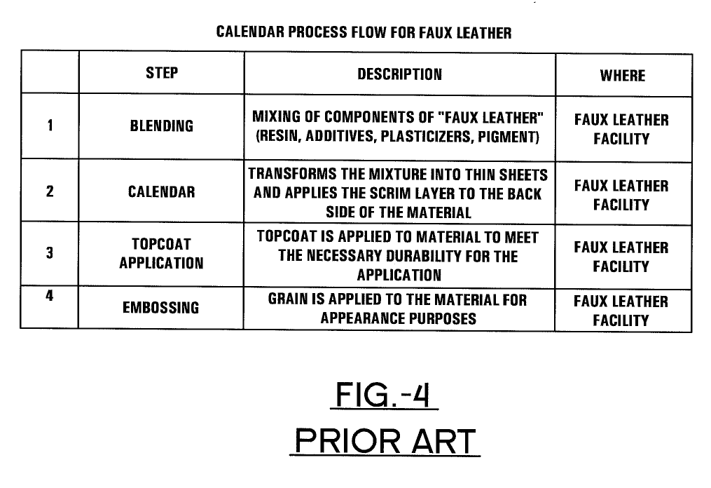

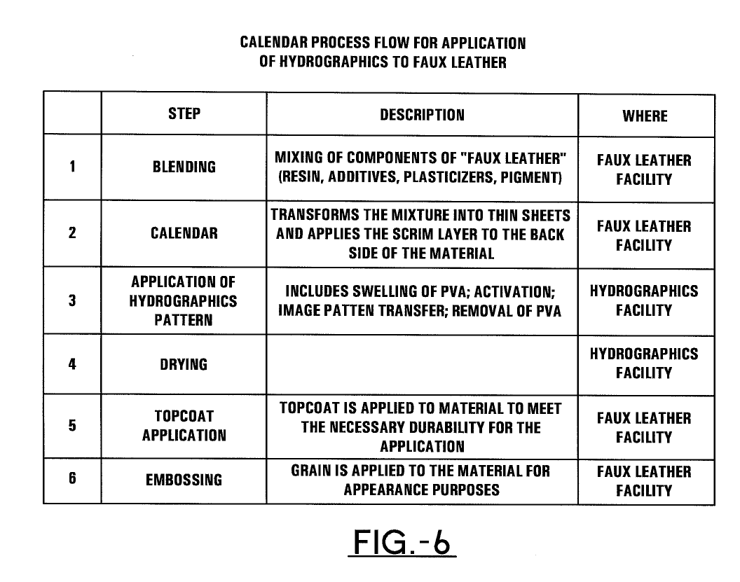

With reference now to FIGS. 2, 4, and 6, the faux leather embodiments for the seating materials 150 will now be described. First it should be noted that by “faux leather” it is meant artificial leather materials including, but not limited to, poly-vinly chloride (PVC), thermo-plastic urethane (TPU), polyurethane (PU), and the like. To better understand the faux leather embodiments of the invention, FIG. 4 shows a typical process flow for faux leather without hydrographic printing, such as may be used to make faux leather seating material. Specifically, FIG. 4 describes a process using a calander machine. First, the components of the faux leather (for example, resin, additives, plasticizers, pigments, etc., to make a synthetic leather) are placed in a batch mixer where they are blended or mixed to create a uniform material. Next, the material goes through the calandering step. In this step, the material is sent through a series of larger rollers, each set at a predetermined temperature and at a predetermined distance apart from one another. Typically the material goes through such rollers multiple times and each time more material is added until the desire thickness and mass is achieved. After this, the material goes through another set of rollers with the base fabric. This fabric has an adhesive on the side facing the faux leather. Once the base fabric enters the rollers with the synthetic leather, it is laminated to the backside of the synthetic leather and acts as the scrim layer. To apply a hydrographic printing design to faux leather seating material, additional steps are required. FIG. 6 shows one embodiment of a process flow for faux leather with hydrographic printing, such as may be used to make faux leather seating material. It should be noted that the process flows shown in FIGS. 4 and 6 are exemplary only (not every step is required in all applications and non-calandering processes are also possible) and should not be used to limit this invention in any manner. The additional steps shown in FIG. 6 are steps 3 and 4. For step 3, the application of the hydrographic printing design in one embodiment may include the same steps as discussed above regarding the general process for applying hydrographic printing to a part. Note that for the embodiment shown, the location where steps 1-2 and 5-6 occur is a faux leather facility and the location where steps 3-4 occur is at a hydrographics facility that is not at the same site as the faux leather facility. In an alternate embodiment, the hydrographics facility may be at the same site as the faux leather facility.

With reference now to all the FIGURES, once the hydrographic printing design has been applied to the leather hide and/or faux leather piece, and the seating material 150 is otherwise properly prepared, the seating material 150 may then be applied to one or more seat cushions 120 in any manner chosen with the sound judgment of a person of skill in the art. In one embodiment, the seating material 150 has an inner side that covers at least a portion of an outer surface of a seat cushion 120 and an outer side, opposite the inner side, that has the hydrographically applied printing design thereon. The hydrographically applied printing design may be positioned to be visible by an observer of the seat assembly 100. Numerous embodiments of application are envisioned including: using one or more seat cushions 120 on a single seat assembly 100; using one or more pieces of seating material 150 on a single seat cushion 120; and, using a combination of seating materials formed of leather and/or faux leather and/or neither leather nor faux leather on the same seat cushion 120 and/or seat assembly 100.

Numerous embodiments have been described, hereinabove. It will be apparent to those skilled in the art that the above methods and apparatuses may incorporate changes and modifications without departing from the general scope of this invention. It is intended to include all such modification and alterations in so far as they come within the scope of the appended claims or the equivalents thereof.

What is claimed is:

1. A vehicle seat assembly comprising:
a seat assembly that supports an associated person in a sitting position and that is operatively attachable to an associated vehicle, the seat assembly comprising a first seat cushion that cushions the associated person while sitting; and,
a first piece of seating material that is operatively attached to the seat assembly and that is formed of one of leather and faux leather, the first piece of seating material having an inner side that covers at least a portion of an outer surface of the first cushion and an outer side opposite the inner side that has a hydrographically applied printing design thereon.

2. The vehicle seat assembly of claim 1 wherein the first piece of seating material is formed of leather.

3. The vehicle seat assembly of claim 2 wherein the first piece of seating material is formed using the following process:
(A) providing a leather hide;
(B) applying a first base coat to the leather hide;
(C) applying a hydrographic pattern to the leather hide; and,
(D) applying a topcoat to the leather hide.

4. The vehicle seat assembly of claim 1 wherein the first piece of seating material is formed of faux leather.

5. The vehicle seat assembly of claim 4 wherein the first piece of seating material is formed using the following process:
(A) providing a faux leather piece;
(B) pre-forming the faux leather piece so that it become suited for hydrographics;
(C) applying a hydrographic pattern to the faux leather piece; and,
(D) applying a topcoat suitable for automotive durability to the faux leather piece.

6. The vehicle seat assembly of claim 1 further comprising:
a second seat cushion that cushions the associated person while sitting; and,
a second piece of seating material that is operatively attached to the seat assembly and that is formed of one of leather and faux leather, the second piece of seating material having an inner side that covers at least a portion of an outer surface of the second cushion and an outer side opposite the inner side that has a hydrographically applied printing design thereon.

7. The vehicle seat assembly of claim 1 further comprising:
a second piece of seating material that is operatively attached to the seat assembly and that is formed of one of leather and faux leather, the second piece of seating material having an inner side that covers at least a portion of an outer surface of the first cushion and an outer side opposite the inner side that has a hydrographically applied printing design thereon.

8. The vehicle seat assembly of claim 1 wherein:
the seat assembly comprises a seat base portion; and,
the first seat cushion is attached to the seat base.

9. A method comprising the steps of:
(A) providing a leather hide;
(B) applying a first base coat to the leather hide;
(C) applying a hydrographic pattern to the leather hide; and,
(D) applying a topcoat to the leather hide.

10. The method of claim 9 wherein step (C) comprises the steps of:
cutting the leather hide to form a hydrographic area; and,
applying the hydrographic pattern to the hydrographic area.

11. The method of claim 9 wherein after step (C) and before step (D) the method comprises the step of:
drying the leather hide.

12. The method of claim 9 wherein:
steps (B) and (D) occur at a leather finishing facility; and,
step (C) occurs at a hydrographics facility that is not at the same site as the leather finishing facility.

13. The method of claim 9 wherein after step (B) and before step (C) the method comprises the step of:
applying a second base coat to the leather hide.

14. The method of claim 9 wherein after step (B) and before step (C) the method comprises the step of:
embossing the leather hide.

15. The method of claim 14 wherein:
after step (A) and before step (B) the method comprises the steps of: milling the leather hide; and, staking the leather hide;
after step (B) and before step (C) the method comprises the step of: drying the leather hide;
after step (C) and before step (D) the method comprises the steps of: drying the leather hide; milling the leather hide; and staking the leather hide; and,
after step (D) the method comprises the steps of: drying the leather hide; and, staking the leather hide.

16. The method of claim 9 wherein:
the method further comprises the step of: providing a seat assembly that supports an associated person in a sitting position and that is operatively attachable to an associated vehicle, the seat assembly comprising a seat cushion that cushions the associated person while sitting; and,
after step (D) the method comprises the step of: using the leather hide as a seating material by covering at least a portion of an outer surface of the cushion with the leather hide such that the hydrographic pattern is visible.

17. A method comprising the steps of:
(A) providing a faux leather piece;
(B) pre-forming the faux leather piece so that it become suited for hydrographics;
(C) applying a hydrographic pattern to the faux leather piece; and,
(D) applying a topcoat suitable for automotive applications to the faux leather piece.

18. The method of claim 17 wherein after step (C) and before step (D) the method comprises the step of:
drying the faux leather piece.

19. The method of claim 17 wherein:
steps (B) and (D) occur at a faux leather facility; and,
step (C) occurs at a hydrographics facility that is not at the same site as the faux leather facility.

20. The method of claim 17 wherein:
the method further comprises the step of: providing a seat assembly that supports an associated person in a sitting position and that is operatively attachable to an associated vehicle, the seat assembly comprising a seat cushion that cushions the associated person while sitting; and,
after step (D) the method comprises the step of: using the faux leather piece as a seating material by covering at least a portion of an outer surface of the cushion with the faux leather piece such that the hydrographic pattern is visible.
